(19) United States
(12) Patent Application Publication
(10) Pub. No.: US 2016/0010383 A1
(43) Pub. Date: Jan. 14, 2016

(54) METHOD FOR OPENING DOORS

(71) Applicant: STOPLIGHT AS, Oslo (NO)

(72) Inventors: Paul Nicholay FAGERSAND, Oslo (NO); Audun Olav BRANDAL, Oslo (NO)

(73) Assignee: STOPLIGHT AS, Oslo (NO)

(21) Appl. No.: 14/773,154

(22) PCT Filed: Mar. 6, 2014
(86) PCT No.: PCT/IB2014/059491

§ 371 Date: Sep. 4, 2015

(30) Foreign Application Priority Data
Mar. 7, 2013 (NO) 20130351

(51) Int. Cl. E05F 15/74; E05F 15/79; E05F 15/603

(52) U.S. Cl. CPC E05F 15/74; E05F 15/603; E05F 15/79; E05Y 2400/858; E05Y 2400/86; E05Y 2400/44

(57) ABSTRACT

A method and device for opening a door in a hygienic manner, is done by positioning a foot or hand in a specific defined area so that a light beam that is directed towards the area is interrupted within a set range of distances such that an automatic opening mechanism for the door is activated.

The present invention relates to a method and device for opening a door. More specifically, a hygienic manner of opening a door is described.

### BACKGROUND FOR THE INVENTION

Doors are found everywhere for opening and closing access between two rooms or zones. Most doors are opened manually by operating a closing mechanism and/or by pushing the door open using a hand or foot. There may also be different types of switches that are operated to activate a mechanism for opening a door.

It is well known that infection spreads via door handles or door-opening switches. In different institutions, and especially in hospitals, it is very important that infection is prevented to the greatest possible extent.

In such locations therefore, in connection with opening doors, motion detectors are often installed, which, on detection of motion in an area in front of a door, activate an opening mechanism. However, it is not always desirable that a door opens whenever a person passes in front of it without intentionally wanting to open it.

There are therefore different types of alternative door switches that can intentionally be used without having to use the palm of the hand. An example of such a switch is an oblong, narrow switch that is typically positioned on the wall at the side of a door that is to be opened, which switch is intended to be operated by using an elbow. Such switches are found, inter alia, in many hospitals today.

However, this is a relatively awkward way of opening a door and is often used incorrectly in that the palm of the hand is used to operate the switch, thereby allowing infection to spread.

The object of the present invention is to provide a new method and device for opening a door in a hygienic manner.

### BRIEF DESCRIPTION OF THE INVENTION

The present invention is described by a method for opening a door in a hygienic manner, this being done by directing a light beam from a device contained within a door switch towards a specific defined area; detecting whether the light beam is interrupted and also where in the path of the light beam it is interrupted, and activating an opening mechanism for the door when the light beam is interrupted within a set range of distances along the path of the beam.

Additional features of the invention are described in the dependent claims of the set of claims.

The invention is also described by a door switch for opening a door in a hygienic manner, the switch comprising a device for emitting a light beam that is directed towards a specific defined area, and where the door switch further comprises detection means for detecting whether the light beam is interrupted and where in its path the light beam is interrupted, and activating means for sending activating signals to an opening mechanism for the door when the light beam is interrupted within a set range of distances along the path of the beam.

Additional features of the door switch are described in the dependent claims.

### DETAILED DESCRIPTION

The invention will now be described in more detail with reference to the figures and to examples of implementation.

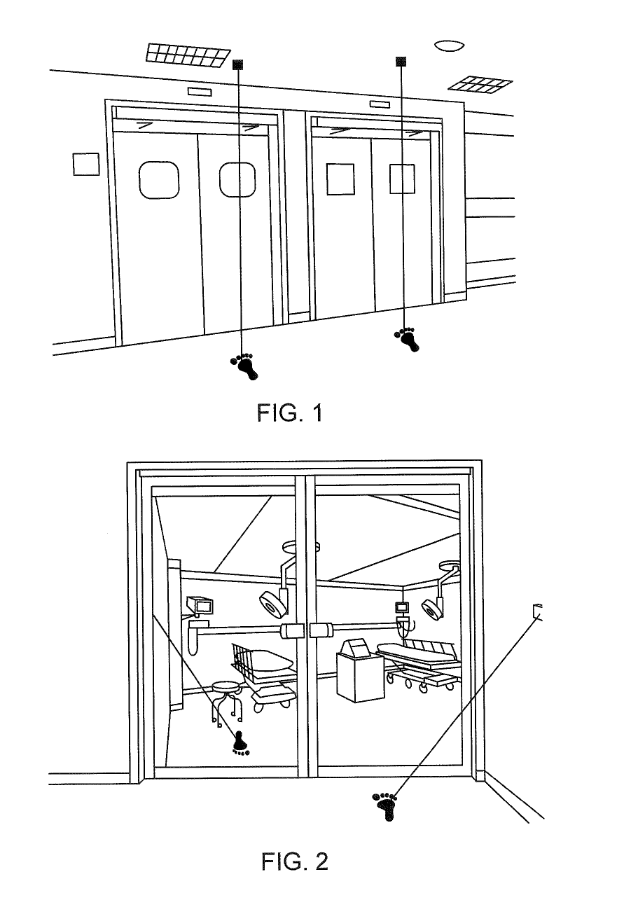

FIG. 1 shows one implementation of a door switch according to the invention;

FIG. 2 shows another implementation of a door switch according to the invention; and

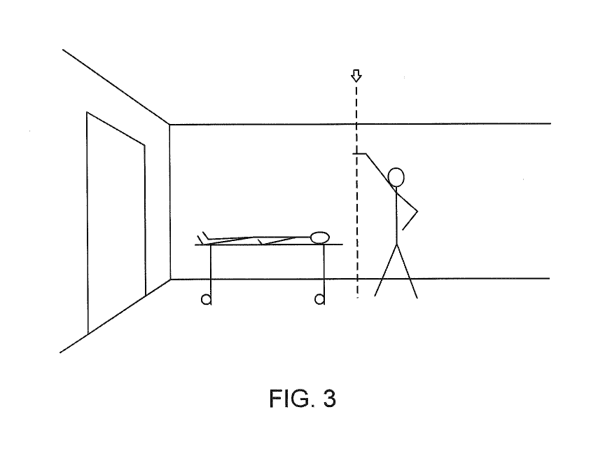

FIG. 3 shows yet another implementation of a door switch according to the invention.

As mentioned, the invention is described by a method for opening a door in a hygienic manner. This is done by positioning a foot or hand in a specific defined area so that a light beam directed towards the area is interrupted and an automatic opening mechanism for the door is activated.

FIG. 1 shows an embodiment of the invention with the said specific defined area marked on a floor in proximity to doors that are to be opened, and where a foot is placed on the marked spot in order to open the door. The light beam is directed towards the marked spot.

In order for a foot to activate the opening mechanism for a door, the foot must be placed on the marked spot. It is only when the beam is interrupted at a predetermined distance within a set range of distances along the path of the beam from the device emitting the beam that activation will take place. Activation will not take place if the foot interrupts the beam in an area outside the said range.

The advantage of activating the opening mechanism by interrupting the light beam only within a range of distances is that the door will only be opened by an intentional and desired action in that a person must place his foot in the exact location of the marked spot.

If a person passes through the light beam such that, for example, his head or shoulder interrupts the beam, the opening mechanism will not be activated since the light beam has not been interrupted within the set range of distances.

If the floor on which the marked spot is located is to be washed, it will be possible to do so without activating the opening mechanism. If, e.g., a mop is passed over the spot, this will not activate the opening mechanism since the mop will be able to pass below a predetermined range of distances that define trigger points, i.e., the distance along the path of the beam from the device emitting the beam.

In an embodiment of the invention, the light beam must be interrupted at said predetermined distance for a given length of time before activation of an automatic opening mechanism will take place.

In another embodiment, time-limited access to a room or zone may be set so that activation of the opening mechanism will only take place within set time intervals.

The marked spot may in an embodiment represent a print of a foot. In other embodiments it may represent other symbols to indicate where a foot should be placed in order to open a door. The marked spot may also be configured as a raised area so as to allow the location of the spot to be felt.

In one implementation of the invention where a door is to be opened by placing a foot on a marked spot, the specific defined area may be next to or in proximity to the wall in which the door is placed. A solution of this kind means that the said light beam that is interrupted will be emitted from a device that has been installed where an earlier mechanical operating switch for the door was located.

FIG. 2 shows an example of this where a light beam from a door switch is directed towards a specific defined area on the floor, which area is marked by a footprint. A person who is to open the door then puts his foot on a marked spot on the floor towards which the light beam is directed, so that the light beam is interrupted at a set distance and an opening mechanism for the door is activated.

In a typical implementation of the invention, the said area is in a natural walking zone, e.g., 1 to 3 metres from the door to be opened. A person walking towards the door will then easily be able to adapt his stride to strike the marked spot with his foot, and quickly and efficiently initiate opening of the door.

In another embodiment of the invention, the said specific area is a marked spot in a ceiling in proximity to the door to be opened, and where a hand must be moved above head height towards the marked spot in order to open the door.

The marked spot may in an embodiment represent a print of a hand. In other embodiments it may represent other symbols to indicate where a hand is to be positioned or directed towards the marked spot in order to open a door.

In an implementation of the invention where a door is to be opened by moving a hand towards a marked spot, the specific defined area may be next to or in proximity to the wall in which the door is located. A solution of the kind means that the said light beam that is interrupted may exit from a device that is located, for example, at a height on the wall above normal head height for an adult person. A person who is to open the door raises his hand towards a marked spot in the ceiling, such that the light beam is interrupted at a given height, and an opening mechanism is activated.

The invention can also be used to replace door latches on ordinary door leaves. In an implementation of this kind, the marked spot may be right by the door leaf on the side of the door that does not face into the room. When a person puts his foot on the marked spot, this will initiate opening of the door in that the door latch has an automatic mechanism that opens it, and the door is opened in that the door leaf itself is pushed open by means of an automated opening mechanism.

FIG. 3 shows another implementation of the invention where the said area is in a natural walking zone 2 to 5 metres from the door to be opened. A person wheeling, for example, a bed in front of him and walking towards the door will then easily be able to raise his hand towards a marked spot in the ceiling for quick and efficient opening of the door before the bed reaches it. When the hand interrupts the beam within a set distance range from the device from which the beam is emitted, the opening mechanism will be activated. The solid line in the light beam path where the hand strikes indicates the distance at which activation will take place when the light beam is interrupted.

The present invention also comprises a door switch with activating means in order to open a door in a hygienic manner. The door switch comprises transmitter means for emitting a narrow light beam that is directed towards a specific defined area, detection means for detecting that the light beam is interrupted at a set distance from the device, and activating means for sending activating signals to an automatic opening mechanism for the door.

The means for transmitting the narrow light beam can in an embodiment of the door switch be incorporated in an adjustable holder such that the angle at which the light beam exits the door switch can be changed.

This will be a suitable solution when the door switch according to the invention is implemented as shown in FIG. 2. The figure shows a door switch according to the invention that is mounted in order to replace a conventional mechanical switch on the wall.

After mounting the door switch on the wall, the beam can be directed against a selected defined area on the floor.

In an embodiment of the door switch, it comprises calculating means for determining the distance to the floor that the emitted beam strikes, and also a range of distances over this distance corresponding to the height of a foot, e.g., 3-9 cm above the floor. In such an embodiment of the door switch, it will be automatically set and calibrated in accordance with a desired range that activates the door switch when the light beam is interrupted.

The light beam used in the invention may be a laser beam. It may also be another type of focused light, for example, infrared light (IR) or light from LED. IR can also be combined with use of ultrasound to improve the accuracy of the distance measurement. A light generating device that is implemented in a device according to the invention also comprises detection means for detecting a change in the light beam, for example, interruption thereof or phase difference when using laser. The devices including the detection means are connected to an automated opening mechanism for a door.

It should be understood that different types of doors can be opened using the invention. These include hinged doors, sliding doors and swing doors. The invention is not limited to use in hospitals, but can advantageously be used in, e.g., factories, garages etc.

The invention solves a problem that is associated with the fact that doors that are intended to be opened in a hygienic manner, by the use of an elbow on a switch, are not used as intended, such that infection is nevertheless spread via such switches for doors. It is furthermore not always desirable to have doors that open automatically based on motion detectors in proximity to a door. Such solutions often open a door even though this was not the intention.

The present invention solves these problems in that a door can be opened by interrupting a beam within a set range of distances along the path of the beam.

1. A method for opening a door in a hygienic manner, comprising:
directing a light beam from a device contained in a door switch towards a specific defined area;
at least one of:
placing a foot on the defined area which is a marked spot on a floor in the proximity to a door to be opened; and
moving a hand above head height towards the defined area which is a marked spot on a ceiling in the proximity to a door to be opened;
detecting whether the light beam is interrupted and also where in the path of the light beam the interrupted occurred; and
activating an opening mechanism for the door when the light beam is interrupted within a set range of distances along the path of the beam.

2. The method according to claim 1, wherein in the activating step, the opening mechanism for the door is activated when the light beam is interrupted for a given length of time within the set range of distances along the path of the beam.

3. (canceled)

4. The method according to claim 1, characterised by wherein the marked spot on the floor is raised so that the marked spot on the floor can be felt.

5. The method according to claim 1, wherein the marked spot on the floor is configured as a print of a foot.

6. The method according to claim 1, wherein the marked spot on the floor is placed next to a wall in proximity of a door that is to be opened.

7. The method according to claim 1, wherein the marked spot on the floor is placed in a natural walking zone 1 to 3 meters from the door to be opened.

8. (canceled)

9. The method according to claim 1, wherein the marked spot on the ceiling is configured as a print of a hand.

10. The method according to claim 1, wherein the marked spot on the ceiling is placed next to a wall of a door that is to be opened.

11. The method according to claim 1, wherein the marked spot on the ceiling is placed in a natural walking zone 2 to 5 meters from the door to be opened.

12. (canceled)

13. (canceled)
